(19) United States
(12) Patent Application Publication
(10) Pub. No.: US 2006/0215179 A1
(43) Pub. Date: Sep. 28, 2006

(54) Laser calibration apparatus

(76) Inventors: David Roberts McMurtry, Dursley (GB); Raymond John Chaney, Berkeley (GB); Mark Adrian Vincept Chapman, Wotton-under-Edge (GB); Stephen Mark Angood, Stroud (GB)

Correspondence Address: OLIFF & BERRIDGE, PLC, P.O. BOX 19928, ALEXANDRIA, VA, 22320, US

(21) Appl. No.: 10/518,918

(22) PCT Filed: Jul. 7, 2003
(86) PCT No.: PCT/GB03/02915

§ 371 Date: Mar. 1, 2006

(30) Foreign Application Priority Data
Jul. 5, 2002 (GB) 0215557.0

(51) Int. Cl. G01B 5/004; G01B 11/14

(52) U.S. Cl. 356/622; 356/614; 33/1 M; 33/503

(57) ABSTRACT

Apparatus for measuring deviation of a trajectory from a straight line in the movement of a first body with respect to a second body comprising a transmitter unit mounted on one of the bodies and an optic unit mounted on the other of the bodies. The transmitter unit directs at least one light beam towards the optic unit such that two or more light beams are received within it. One of the units is provided with two or more detectors to detect the light beams transmitted to or reflected from the optic unit. The position of the light beams on the detectors is used to calculate the deviation of a trajectory from a straight line of one of the bodies with respect to the other in at least one degree of freedom. This enables measurement of straightness, pitch, roll, yaw and squareness errors.

The present invention relates to optical apparatus for measuring deviations of a trajectory from a straight line. More particularly, the invention relates to optical apparatus for measuring deviations of a trajectory from a straight line in the movement of a first machine component relative to a second machine component. The machine components may be parts of a coordinate positioning apparatus which may comprise, for example, a machine tool or a coordinate measuring machine.

Deviations in the movement of a machine component as it moves along a trajectory generally involve rotation of the component about one or more axes of the machine, usually referred to as the X,Y and Z axes, and are referred to as pitch, roll and yaw errors. There are also errors in straightness of the movement which involve lateral deviations of the machine component from the main movement axis.

U.S. Pat. No. 4,939,678 discloses a method of calibrating a coordinate measuring machine in which laser measuring head is mounted onto a first part of a machine and a reflecting assembly is mounted on a second part of the machine. A pair of light beams are transmitted from the laser measuring head and reflected by the reflector assembly towards a pair of quad cells in the laser measuring head. The position of the return beams on these quad cells allows the straightness and roll of the reflector assembly to be measured. A separate beam, plane mirror and detector arrangement is used to measure pitch and yaw. This system only allows 18 degrees of freedom to be measured.

A first aspect of the present invention provides apparatus for measuring deviation in the movement of a first body with respect to a second body comprising:

a transmitter unit mountable on the first body;

an optic unit mountable on the second body;

wherein the transmitter unit directs at least one light beam towards the optic unit;

wherein one of the transmitter unit and the optic unit is provided with two or more detectors to detect two or more light beams transmitted to or reflected from the optic unit,

wherein the optical arrangements for launch and detection of each light beam are substantially the same.

The launch is the effective start of the light beam and may comprise, for example, an optical fibre end.

Preferably the detectors comprise two-dimensional arrays of pixels. The detectors may comprise, for example, charge-coupled devices (CCDs), CMOS sensors or charge-injection devices (CID).

Preferably the optic unit is mounted on a movable body. The optic unit preferably has no trailing leads which could cause unwanted movement and affect the accuracy. Preferably the apparatus also includes linear displacement measuring apparatus, such as an interferometer. This may comprise a light source in the transmitter unit to produce a light beam which is directed to the optic unit, a retroreflector in the optic unit to reflect the light beam towards the transmitter unit, and a fourth detector in the transmitter unit to detect the returning light beam.

A second aspect of the invention provides apparatus for measuring deviation in the relative movement between a first body and a second body, the apparatus comprising:

a transmitter unit mountable on the first body and an optic unit mountable on the second body;

the transmitter unit being provided with one or more detectors and wherein the transmitter unit directs at least one light beam towards the optic unit;

the optic unit being provided with three retroreflectors to reflect three beams of light towards the transmitter unit;

wherein the position of the three reflected light beams on the one or more detectors is used to determine the deviation of the trajectory from a straight line in five degrees of freedom.

Preferably the five degrees of freedom are pitch, yaw, roll and straightness along two axes perpendicular to the axis of movement of the first or second body.

A third aspect of the invention provides apparatus for measuring squareness of the axes of a machine having first and second parts movable relative to one another, the apparatus comprising:

a base unit mountable on the first machine part;

a transmitter unit mountable on the base unit, the base unit and at least one surface of the transmitter unit being provided with cooperating elements to define the position of the transmitter unit relative to the base unit in a plurality of known relative orientations of the transmitter unit and thereby define the directions of at least one light beam;

an optic unit mounted on the second machine part;

wherein the transmitter unit directs at least one light beam towards the optic unit;

wherein one of the transmitter unit and the optic unit is provided with one or more detectors to detect one or more light beams transmitted to or reflected from the optic unit;

such that by orientating the transmitter unit along two axes of the base unit and measuring the deviation of the at least one light beam on the at least one detector, the squareness of those two axes can be determined.

A fourth aspect of the invention provides apparatus for measuring deviation in the movement of a first body with respect to a second body comprising:

a transmitter unit mountable on the first body;

an optic unit mountable on the second body;

wherein the transmitter unit directs at least one light beam towards the optic unit;

wherein one of the transmitter unit and the optic unit is provided with one or more detectors to detect one or more light beams transmitted to or reflected from the optic unit;

wherein the position of the light beam on the detector is used as feedback to adjust the position of the transmitter unit or change the movement vector of the second body in order to maintain the light beam on the detector during relative movement of the first and second bodies.

Embodiments of the invention will now be described by way of example and with reference to the accompanying drawings in which:

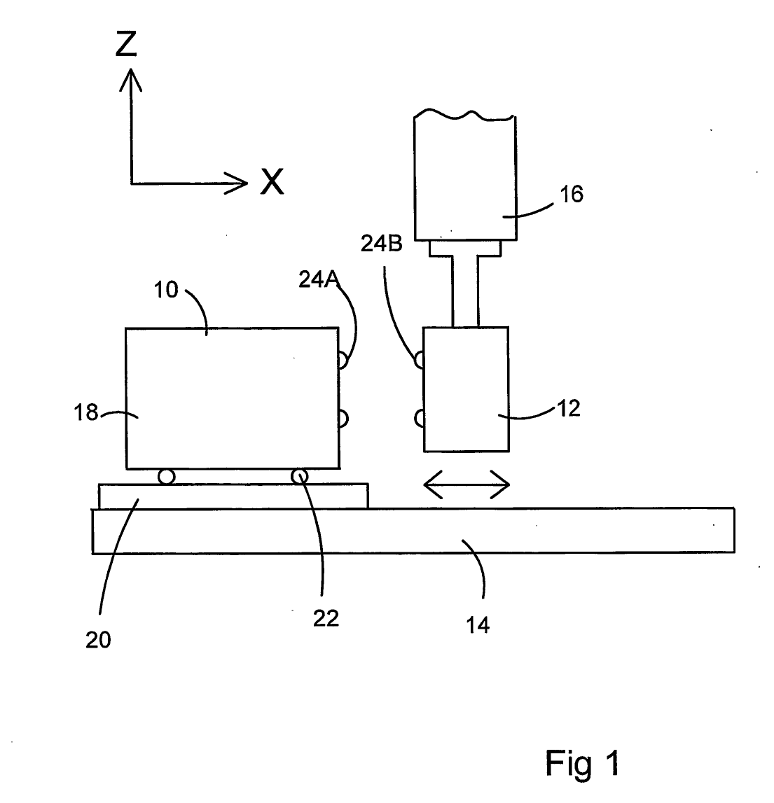

FIG. 1 is a schematic representation of the measuring device mounted on a coordinate measuring machine;

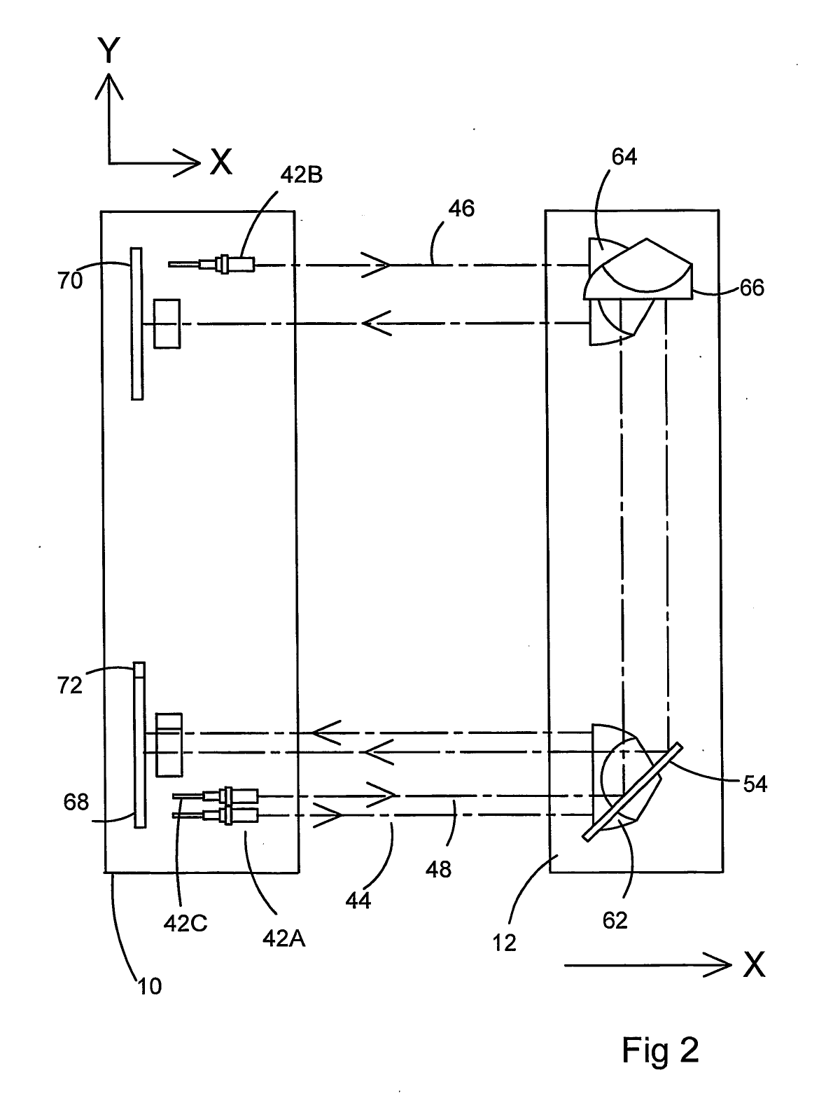

FIG. 2 is a plan view of the optical components in the transmitter unit and the optic unit;

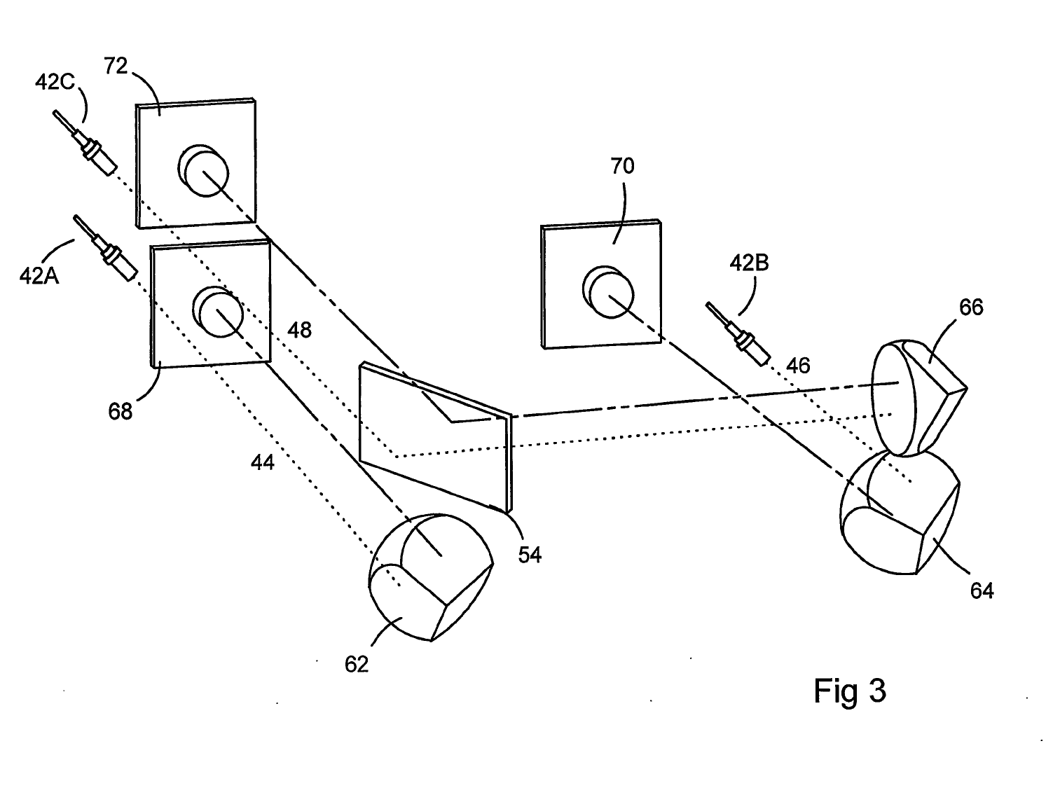

FIG. 3 is a perspective view of the optical components in both the transmitter unit and the optic unit;

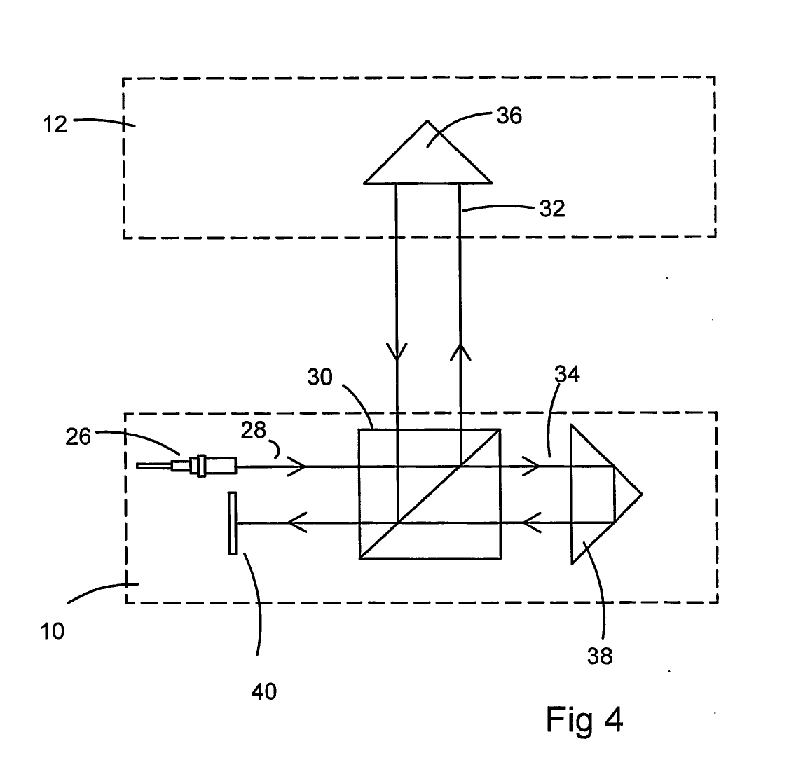

FIG. 4 is a plan view of a linear displacement measuring device in the transmitter unit and the optic unit;

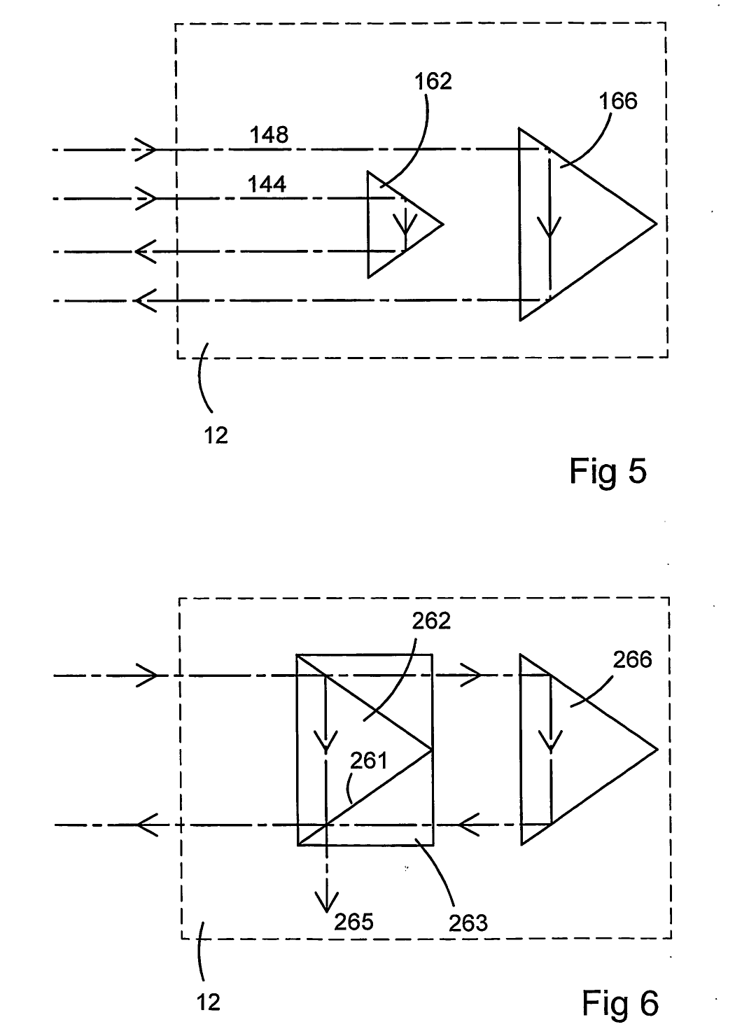

FIG. 5 is a plan view of a first alternative arrangement of the retroreflectors in the optic unit;

FIG. 6 is a plan view of a second alternative arrangement of the retroreflectors in the optic unit;

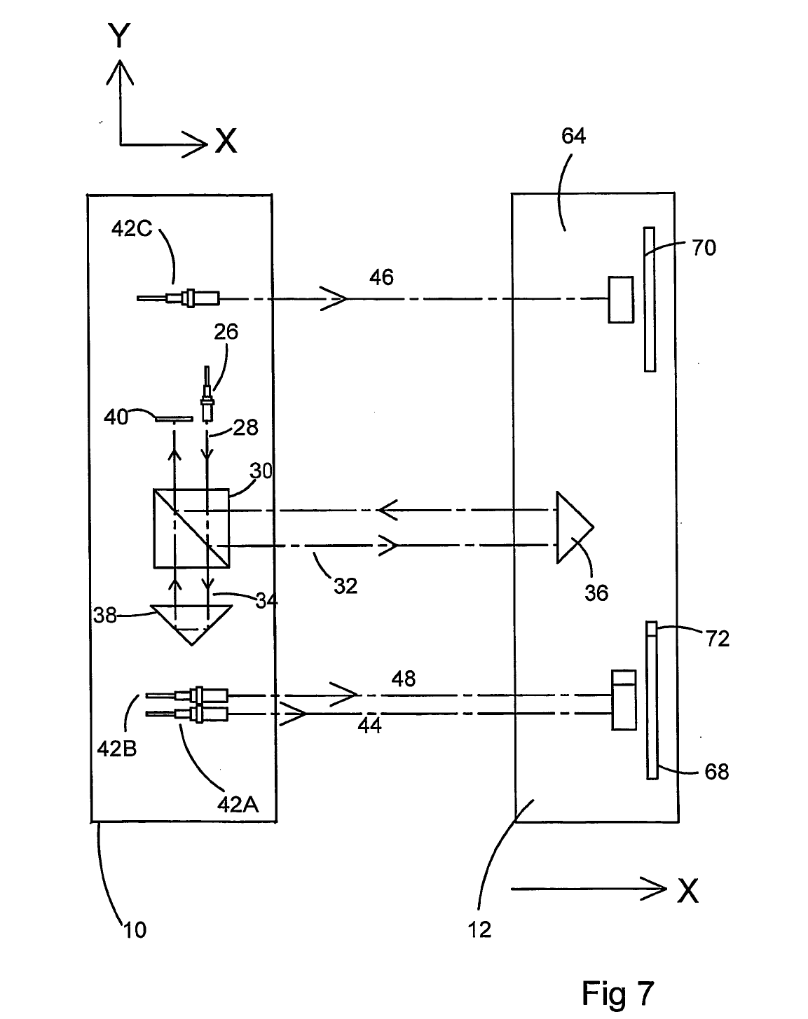

FIG. 7 is a plan view of transmitter unit and the optic unit according to a second embodiment of the invention;

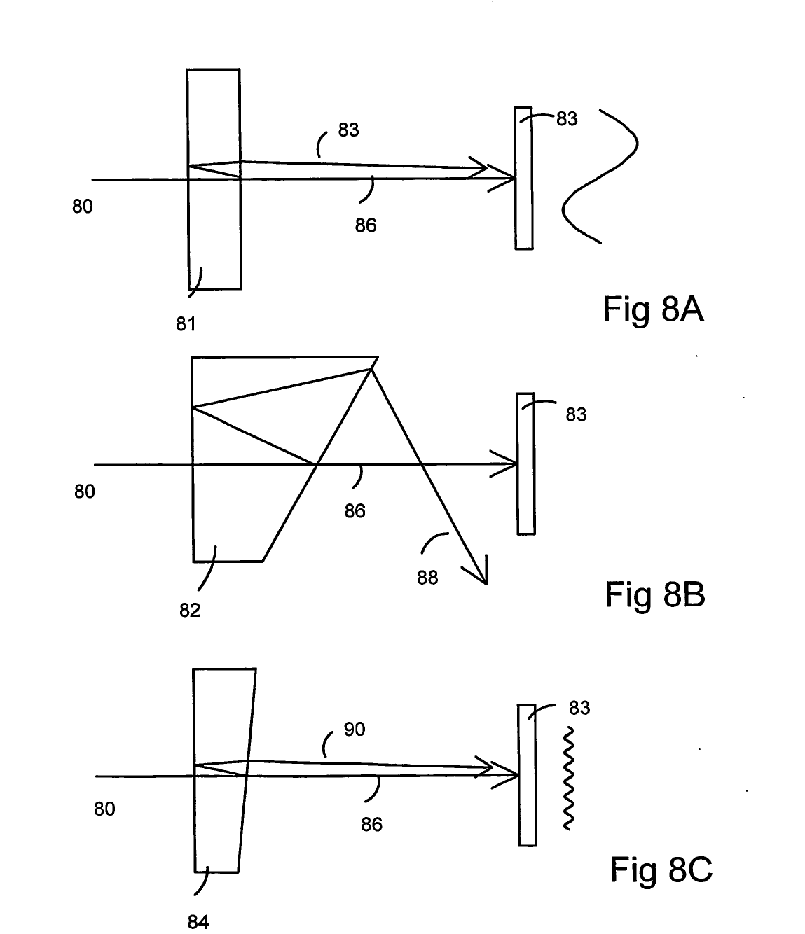

FIGS. 8A-8C illustrate double reflection on a thin plane optical element, a thick wedged optical element and a thin wedged optical element respectively;

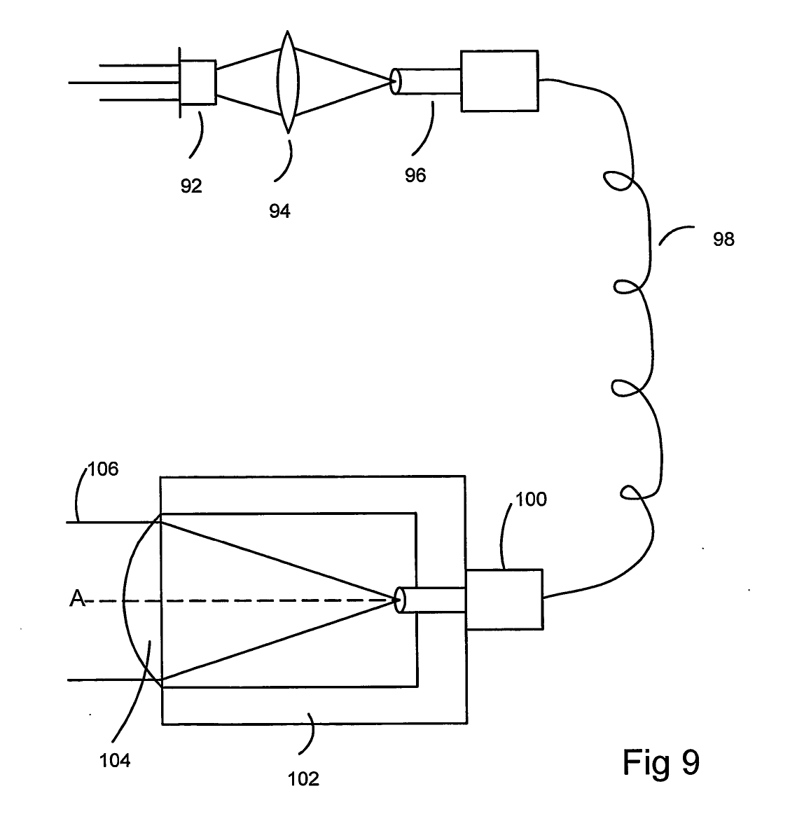

FIG. 9 illustrates an optical fibre coupled to a laser light source;

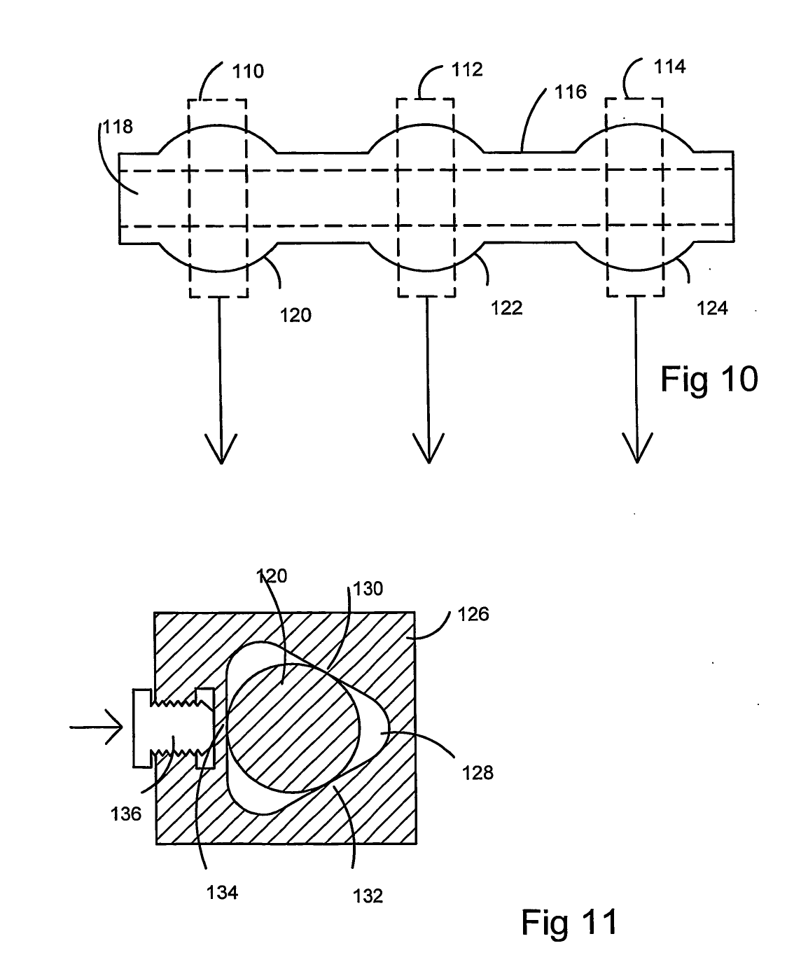

FIG. 10 illustrates the optical fibre ends mounted on a bar;

FIG. 11 illustrates a clamp used to mount the optical fibre ends of FIG. 10;

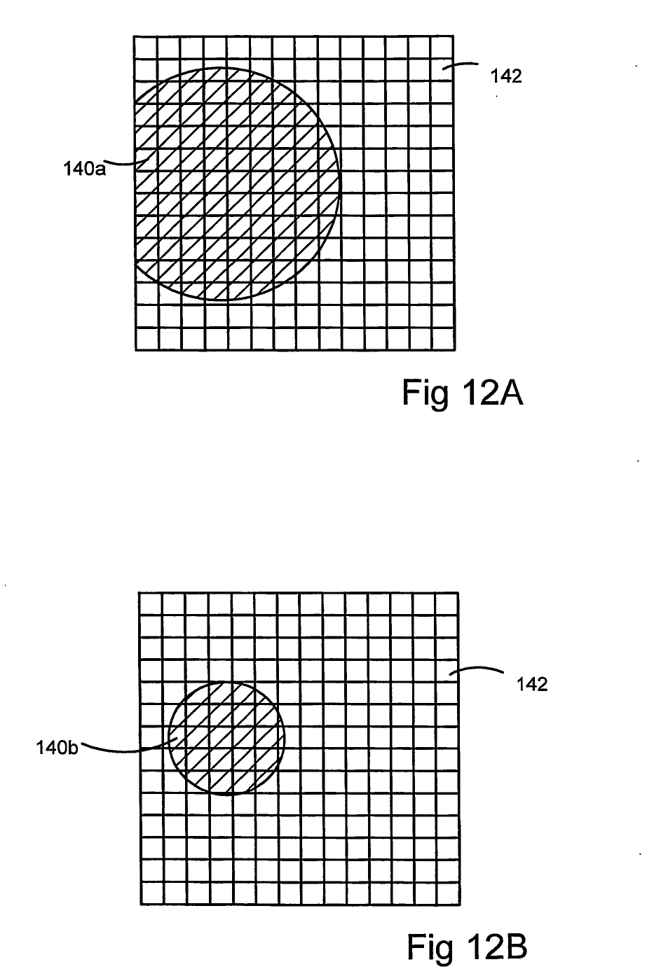

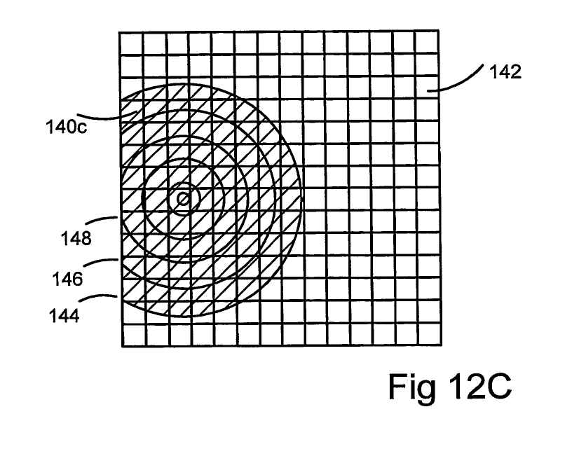

FIG. 12A illustrates a spot on the edge of a sensor;

FIG. 12B illustrates the spot in FIG. 12A once a threshold value has been deducted;

FIG. 12C illustrates the contours in a spot on the edge of the sensor which are used to calculate the centroid.

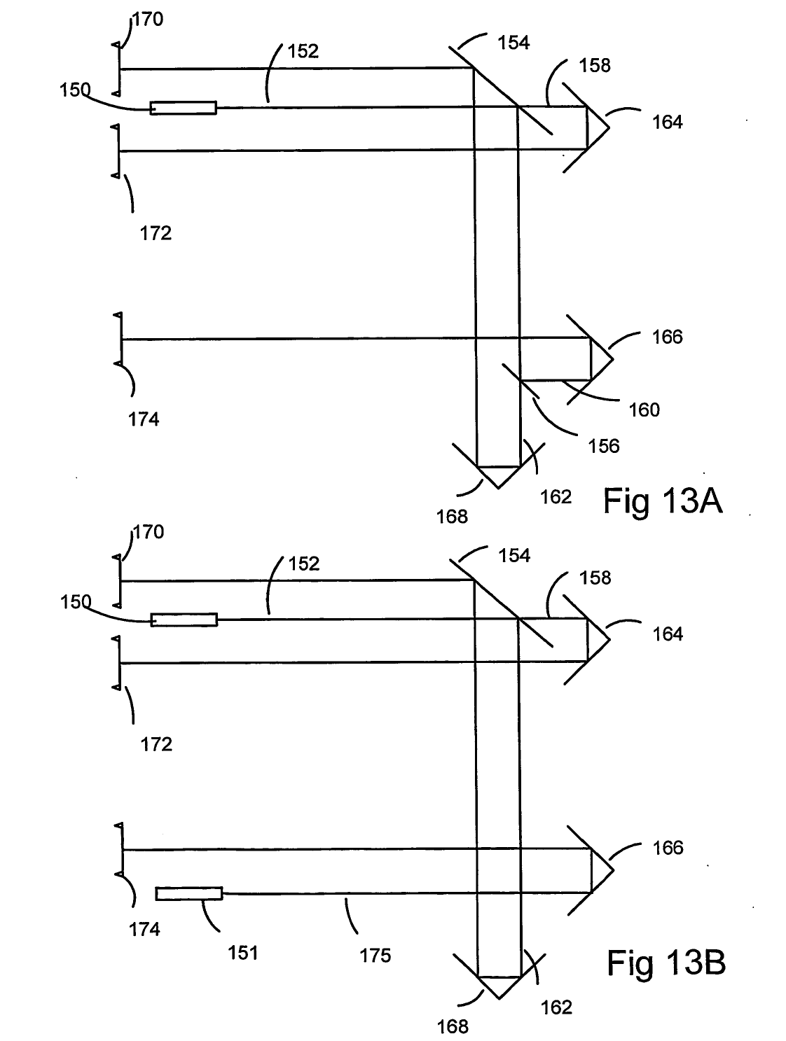

FIGS. 13A and 13B illustrate alternative optical schemes to FIG. 2 in which only one or two beams respectively are transmitted;

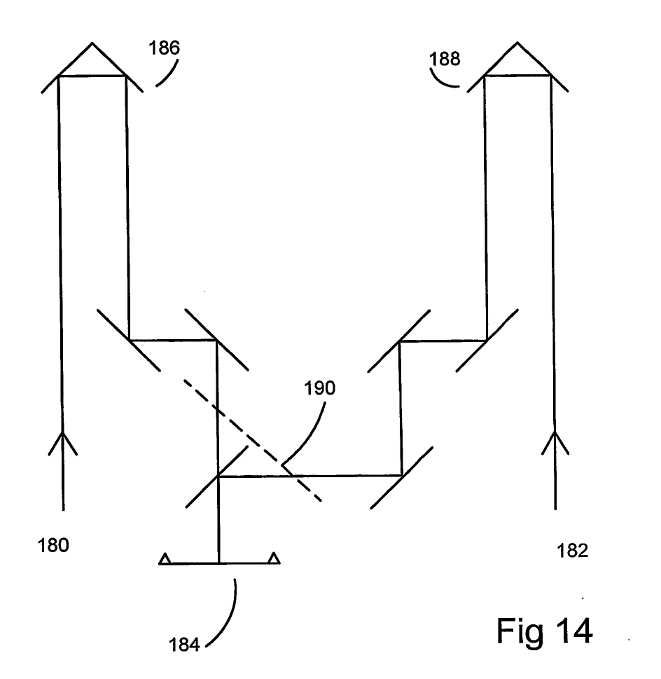

FIG. 14 illustrates an optical scheme in which a single detector is used for two light beams;

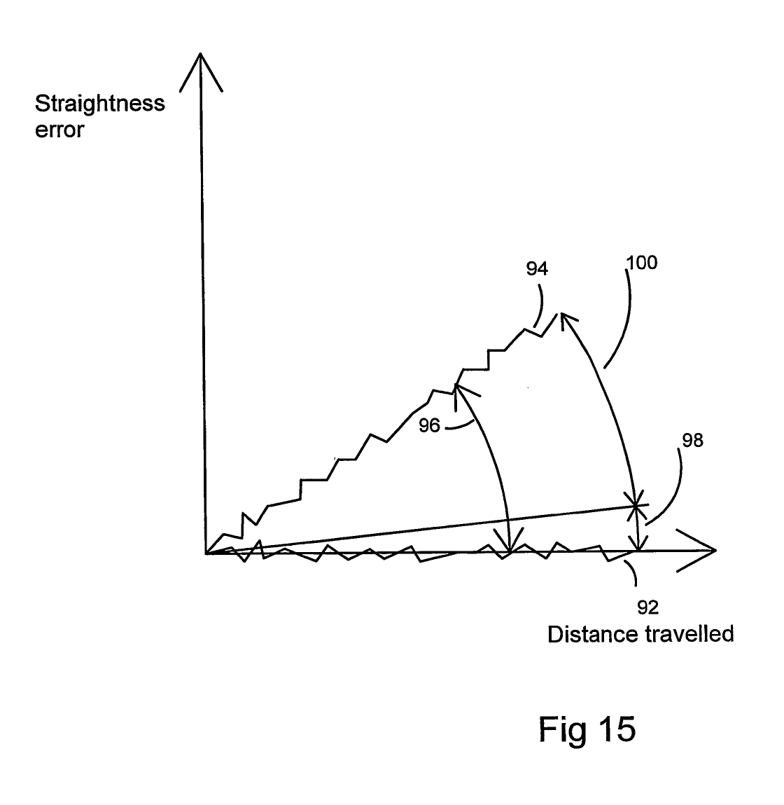

FIG. 15 is a graph of straightness error against distance travelled; and

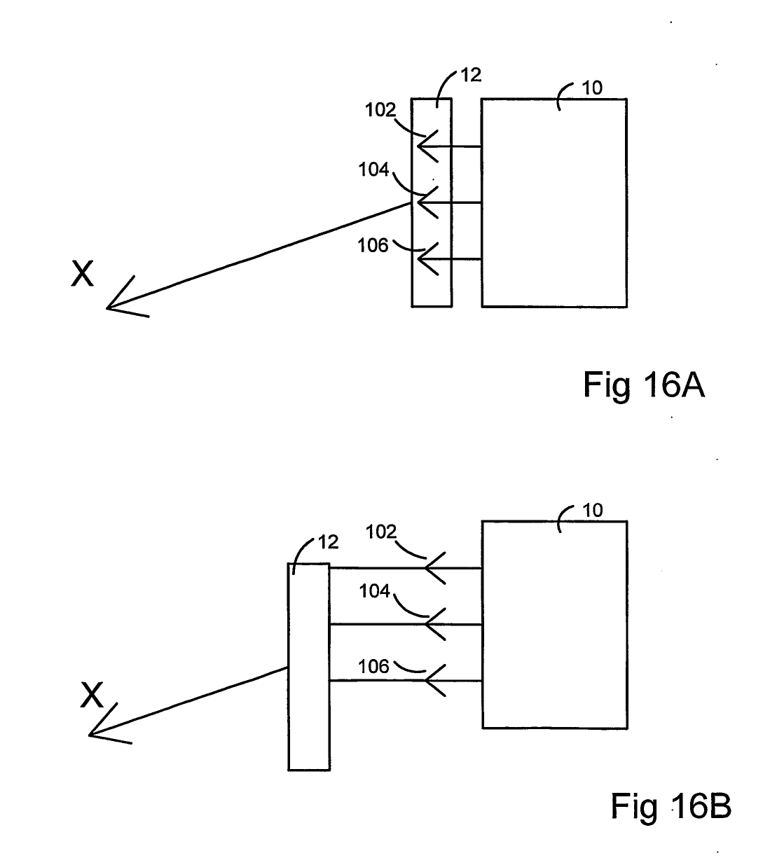

FIGS. 16A and 16B illustrated a transmitter unit which is not aligned to a machine axis.

FIG. 1 shows the calibration apparatus mounted on a coordinate measuring machine (CMM). A transmitter unit 10 is mounted on the machine table 14 of the CMM. As described in our International Patent Application WO02/04890 the base 18 of the transmitter unit 10 and a base unit 20 mounted on the machine table 14 are provided with complementary parts of a kinematic support 22 which enable the transmitter unit 10 to be accurately aligned along any of the X,Y,Z,−X and −Y axes of the CMM or along any other desired direction. An optic unit 12 is mounted on the quill 16 of the CMM. As also described in International Patent Application No. WO02/04890, the transmitter unit 10 and the optic unit 12 have complementary parts of a kinematic support 24A, 24B such that when they are brought into contact with each other, they become accurately aligned with one another.

The transmitter unit 10 is thus mounted on the machine table 14 and aligned with one of the X,Y,Z,−X or −Y axes of the machine or any other desired direction. The optic unit 12 is aligned with the transmitter unit 10 and is mounted on the quill 16 of the machine. The optic unit 12 and quill 16 are moved along a path in the direction to which the transmitter unit 10 is aligned. The apparatus may then be used to measure the distance of the optic unit 12 from the transmitter unit 10 and to measure deviations in the movement of the optic unit 12 during its movement along this path.

FIGS. 2-4 show the arrangements of the optical elements within the transmitter unit 10 and the optic unit 12. A first group of optical elements 26-40 are used as a linear displacement measuring device, for example an interferometer, to measure the distance of the optic unit from the transmitter unit. These are omitted from FIGS. 2 and 3 for clarity but are shown separately in FIG. 4. Although one particular type of interferometer will be described this may be replaced by any other suitable type of linear displacement measuring apparatus. The interferometer apparatus comprises a light source 26 in the transmitter unit 10 which produces a light beam 28. A beam splitter 30 splits the beam 28 and sends a first beam 32 towards a first retroreflector 36 in the optic unit 12 and a second beam 34 towards a second retroreflector 38 in the transmitter unit 10. Both beams 32,34 are reflected by their respective retroreflectors 36, 38 back to the beamsplitter 30 and on to the detection unit 40. This interferometer is described in more detail in UK patent GB2296766.

The retroreflectors 36,38 used for the linear displacement measuring device may comprise existing retroreflectors in the optic unit (i.e. shared with the straightness/angular deviation optics), in order to reduce size and cost. In this case the incident light beam may be rotationally displaced so that the beams do not overlap.

Referring to FIGS. 2 and 3, three light sources 42A,42B,42C project three substantially parallel light beams 44,46,48 from the transmitter unit 10 to the optic unit 12. The three light sources may comprise, for example, three optical fibre ends in a known manner. Alternatively a single light source may be used which produces a plurality, e.g. three, of parallel light beams by using optics such as beams splitters and mirrors.

The optic unit 12 is provided with three spaced retroreflectors 62,64,66. The retroreflectors 62,64,66 reflect the beams 44,46,48 back towards three detectors 68,70,72 located within the transmitter unit 10. These detectors 68,70,72 may comprise CMOS sensors which comprise two-dimensional arrays of pixels allowing the position of a light beam on the detector to be measured. Alternatively a charge-coupled device (CCD) may also be used in place of the CMOS sensor. Other types of pixelated image sensors, comprising image sensors made up of a two dimensional array of pixels, which allow the position of the light beam to be determined may also be used. Position sensitive detectors (PSDs) are also suitable. These use the voltage difference between opposite sides of the detector to indicates the position of the incident light beam. PSDs may be tuned to work at a particular frequency and may thus be tuned to eliminate room lighting effects by tuning it to a higher or lower frequency than the room lighting. The PSDs are in AC mode. The incident beam on the PSD is intensity modulated and the PSD frequency is turned to that same frequency. Other types of sensor may also be used, for example quad cells.

As the optic unit 12 moves along its path, the positions of the returning light beams 44,46,48 on the detectors 68,70,72 will change, due to deviations in the movement of the optic unit 12 from this path. The use of three retroreflectors 62,64,66 with images laterally displaced with respect to each other enables two straightnesses and pitch, roll and yaw to be deduced of the optic unit.

In this example, the motion of the optic unit is along the X axis of the machine, as illustrated in FIG. 2. Retroreflectors 62 and 64 are located in the optic unit 12 spaced in the Y direction. The straightness of the axis of motion (X axis) of the optic unit is half the mean displacement of the change in position of the light beams 44,46 on detectors 68,70 in the direction of the axes perpendicular to the directions of motion (i.e. Y and Z axes in this case). If, as described below, the detectors are located in the optic unit 12 then the straightness of the axis of motion of the optic unit is the mean displacement of the change in position of the light beams 44,46 on the detectors 68,70 in the direction of the axes perpendicular to the directions of motion.

If the three light beams 44,46,48 directed towards the optic unit 12 are not parallel, a correction must be applied to the detector outputs to correct for this error. If the beams 44,46,48 are mis-aligned, the measurement is corrected from calibration of the two units 10,12.

The roll of the optic unit 12 is measured by the differential displacement in the Z direction between these same two beams 44,46 on their respective detectors 68,70. If the roll centre is located between the two beams 44,46 then the information from the detectors 68,70 is sufficient to calculate the roll. However if the roll centre is off-set, the information from the detectors 68,70 contains both linear and rotary data and may be no longer sufficient to accurately calculate the roll. The arrangement of the present invention has the advantage that as retroreflector 66 is vertically displaced from retroreflector 62, information from all three detectors 68,70,72 may be used to enable pure roll to be measured, wherever the roll centre is located.

In order to improve the accuracy of the roll measurement, it is advantageous to use the same detector to measure the position of the two beams. The arrangement illustrated in FIG. 14 enables the deviation of two light beams 180,182 to be detected by a single detector 184. The light beams 180,182 are reflected by retroreflectors 186,188 and directed via mirrors and/or beamsplitters towards the detector 184. A disc 190 provided with an aperture is located in the path of both beams 180,182 and spins at a rate synchronised to the capture rate of the detector. Light from each of the beams 180,182 is therefore alternately incident on the detector 184, producing a chopped signal. Alternatively, the two beams 180,182 may be modulated in order to produce a chopped signal.

The third retroreflector 66 enables the pitch and yaw of the optic unit 12 to be measured. This third retroreflector 66 is placed conceptually behind one of the first and second retroreflectors 62,64 in the optic unit 12. In this example, the third retroreflector 66 is placed vertically above the first or second retroreflector. This is achieved by vertically displacing one of the output beams 48 from the transmitter unit 10 and placing a mirror 54 above one of the retroreflectors 62 to direct the beam 48 towards the retroreflector 66 placed above the other retroreflector 64. Pitch and yaw are measured by the differential displacement on detectors 68,72 between the two beams 44,48 in the Z and X directions respectively.

This apparatus has the advantage that all six degrees of freedom may be measured simultaneously.

Alternative arrangements are possible in which one or two light beams are transmitted from the transmitter unit to the optic unit and split in the optic unit to create three beams. FIG. 13A illustrates a single light source 150 projecting a beam 152 towards the optic unit. The projected beam 152 is split by beam splitters 154 and 156 into three beams 158, 160, 162. These three beams are reflected by retroreflectors 164,166,168 towards detectors 170,172,174. This has the advantage that as common light source is used to create all three beams. Therefore any beam pointing error is common for all three beams and can thus be mathematically removed. However the disadvantage is that there is loss of gain from the displaced beams. In the previous embodiment, each beam had a gain of two at the detector due to the use of retroreflectors. However, as the beam splitter 154 tilts with movement of the optic unit, there is only a gain of one at the detector. For example, for a roll angle of θ, the detector detects a displacement of Lθ in this arrangement, where L is the distance between the retroreflectors. In the previous example, with three outward beams, the displacement was 2Lθ.

As illustrated in FIG. 13B, this is overcome by using a second light source 151 which projects a separate light beam 175 towards retroreflector 166, the reflected beam being detected towards 174. This maintains the gain on the roll measurement but has the disadvantage that two separate light sources are used.

Although the measurement of straightness, pitch, roll and yaw have been described in terms of specific beams and retroreflectors, it is possible to use all three beams and all three detectors to measure the deviation in any degree of freedom and hence a generalised equation can be written as:
Deviation of trajectory from straightline=f(S₁ₓ,S_{1y},S₂ₓ,S_{2y},S₃ₓ,S_{3y},IR)=k₁S₁ₓ+k₂S_{1y}+k₃S₂ₓ+k₄S_{2y}+k₅S₃ₓ+k₆S_{3y}+k₇IR
where k₁,k₂ . . . . k₇ are constants

S₁ₓ,S_{1y} are positions of beam centre on sensor 1 in x and y respectively

IR is Interferometry Reading.

The constants k₁-k₇ are deduced during a calibration procedure and may differ for the deviation in the different degrees of freedom (i.e. straightness, pitch, roll and yaw). Thus a total of 35 constants are deduced during the calibration procedure. (i.e. 7 constants (k₁-k₇) for each of the 5 degrees of freedom).

The k₇IR term in the equation allows non parallel beams to be accommodated.

It is known in prior art systems for measuring straightness and roll, to use quad cells to detect displacement of a beam. However quad cells have several disadvantages. For a quad cell to be accurate, the beam centre must be aligned with approximately the centre of the quad cell. To improve its linearity range, the quad cells are mounted on motors and must be servoed into the desired position during set-up of the system. In addition the homogeneity of the silicon in the quad cell is poor for the accuracy required in the present system, although servo-controlling the quad cells overcomes this problem to the first order.

Another disadvantage of a non servo-controlled quad cell is that as the beam moves away from the centre of the cell, the linearity decreases. To linearise the non-linear equation relating output to beam centre position, the beam size must be known. Furthermore, if the beam moves wholly into a quadrant of the quad cell, it is not possible to determine its position within that quadrant.

In the present invention, pixelated image sensors such as CCDs, CMOS or CIDs are used. These have several advantages over the use of quad cell detectors.

A first advantage is that the beam can be detected anywhere on the pixelated image sensor. As the beam does not need to be aligned with the centre of the sensor, there is no requirement for the sensor to be servoed into position on initial set-up of the system. Furthermore, the sensor is able to detect the beam centres even when the beam is on the edge of the sensor, as will be described in more detail below.

Use of a pixelated image sensor enables the diameter of the detected spot to be known and in addition allows the spot diameter of a percentage of the maximum signal strength to be determined. To determine whether the spot is at the edge of the sensor, a threshold value (for example a reading of 100 of a maximum sensor reading of 4096) is deducted from the sensor reading. If the pixels between the sensor edge and the spot read zero, then the spot is not at the edge of the sensor. If the spot is at the edge, the threshold value may be increased until the pixels between the spot and edge do read zero. The spot centre may then be determined. FIG. 12A illustrates a spot 140a on the edge of a pixelated sensor 142. FIG. 12B illustrates the spot 140b when a threshold value has been subtracted. The whole spot is now on the sensor 142 and its centre may be determined.

The centroid may be calculated in the following manner. Two images have been detected by the sensor, im1 is the image with a light beam incident on the sensor and im2 is the image without a light beam incident on the sensors. The sensor has been calibrated if necessary to take care of difference in optical response of each pixel and also to take into consideration their different areas of sensitivity. This latter could be done by adjusting the signal level or by using non-integer indexing values.

In order to deduce the true signal level im, the two images im1,im2 are subtracted from each other on a pixel by pixel bases and a threshold value t is also subtracted, i.e.:
imᵢⱼ=im1ᵢⱼ−im2ᵢⱼ−t

For all imᵢⱼ<0, the value is set to zero.

The centroid may be calculated using a simple algorithm, by calculating the spatial geometrical centre.

The x and y coordinates of the centroid for a given threshold t are given by:

$${x}_{t} = \frac{Σ i Σ S i , j}{Σ S i , j}$$

and

$${y}_{t} = \frac{Σ j Σ S i , j}{Σ S i , j}$$

where sᵢⱼ is the signal or intensity reading of the i,j^{th} pixel.

This calculation can be repeated for different threshold values, to calculate an overall weighted mean average for the centroid position, i.e.:

$$x = \frac{Σ {W}_{t} {X}_{t}}{Σ {W}_{t}}$$

and

$$y = \frac{Σ {W}_{t} {Y}_{t}}{Σ {W}_{t}}$$

where w is the weight attached to that particular threshold value.

For very high threshold values the weighting factor will be small because fewer pixels are involved in deducing the centroid. For low values of threshold the weighting factor may also be small because of the noise associated with deciding which pixels should and should not be included in the calculation even though these centroid calculations contain the most pixels.

For edge detection one can use the criteria that there should be at least a row of pixels between the spot and the edge of the pixelated sensor. If there is not then one used only those threshold values that meet the criteria.

Alternative algorithms can be used for finding the centroid of a spot, for example curve fitting algorithms, e.g. fitting the intensity profile of the spot to Gaussian or Lorentzian distributions. Other methods of determining the centroid include finding the circle of maximum gradient and then finding the centre. Alternatively the centroid may be determined by finding the mean position of minimum gradient.

Alternatively, if the spot is at the edge of the sensor, the centre may be mathematically deduced. For example as shown in FIG. 12C, contours 144,146,148 of a percentage of maximum signal strength (e.g. 10%, 20% etc) of a spot 140 cmay be determined, fitted to circular contours and used to deduce the spot centre, using least squares fitting or minimum deviation of the minimum maximum radius, for example. This method allows the centroid to be deduced, even if not all the data is present.

Another advantage of using pixelated image sensors is that it is easy to map the variation in silicon on the sensor. This may be done, for example, by uniformly illuminating the sensor and thereby calculating the variation in the silicon as a function of X and Y.

In prior art autocollimators, a light beam is focused onto a spot on a PSD (position sensing detector). A change in the angle of the beam causes displacement of the spot on the PSD, whilst linear movement of the beam does not. However, use of a PSD has the disadvantage of non-homogeneity of the silicon which effects the accuracy. It is not possible to use a pixelated image sensor in this arrangement as the focused spot has a diameter smaller than a single pixel. However, in the method of measuring pitch and yaw in the present invention, in which the differential displacement of two beams 44,48 on detectors 68,72 is measured, pixelated image sensors may be used as the beams do not need to be focused to a spot. Therefore this method benefits from the advantages of a pixelated image sensor described above.

In an alternative embodiment, the third retroreflector may be actually located behind the second retroreflector. FIG. 5 shows such an arrangement in which a large third retroreflector 166 is positioned behind a small second retroreflector 162. The outgoing light beams 144, 148 are arranged such that the beam 148 directed towards the large third retroreflector 166 is not intercepted by the small second retroreflector 162. However this arrangement has the disadvantage that it adds extra volume to the optic unit 12.

Another arrangement of the second and third retroreflectors is shown in FIG. 6 in which the third retroreflector 266 is located behind the second retroreflector 262. The second reflector 262 has a beam splitter surface 261 and prisms 263 located on its rear surface to allow some light to pass through it to the third retroreflector 266 whilst reflecting some light itself. This arrangement has the disadvantage that it is relatively expensive, adds volume to the optic unit and some light 265 is lost perpendicular to the outgoing and incoming beams.

The first arrangement shown in FIGS. 2 and 3 in which the third retroreflector is conceptually behind the second retroreflector introduces cross coupling to the system as the light beams directed to the second and third retroreflectors are angled to one another. This arrangement is advantageous as it is a more compact design, saving volume in the optic unit.

An advantage of the present invention is that in addition to enabling 6 degrees of freedom to be determined along each axis, it also enables squareness to be determined (i.e. the error in the angle of one axis relative to another).

As previously described with reference to FIG. 1, the base 18 of the transmitter unit 10 and a base unit 20 mounted on the machine table 14 are provided with complementary parts of a kinematic support 22 which enable the transmitter unit 10 to be accurately aligned along any of the X,Y,Z,−X and −Y axes of the CMM. The squareness between sets of kinematic supports may be made very precisely so that the transmitter unit can be accurately aligned with any axis. Alternatively, the squareness of the kinematic supports may be made less accurately, with any resulting loss of accuracy i.e. the error in squareness being accommodated for by calibration. The calibration could be provided, for example, by comparison of the angles of the transmitted beams when the transmitter unit is mounted on each orientation of the base plate, and the known axes from an accurately calibrated CMM.

In order to measure squareness, the kinematics between the base plate and the transmitter unit must either be precise, so that the axes of the transmitter unit are square or the error in squareness of the base plate must be known to within a tolerance (i.e. it must have been calibrated).

The transmitter unit is positioned on the base plate so that it is aligned with a first axis. The optic axis is moved by the quill of the machine away from the transmitter along this axis, while the straightness is measured. This is repeated along a second axis.

FIG. 15 illustrates a graph of measured straightness error against the distance travelled by the optic unit away from the transmitter unit. Line 92 is the straightness along the X axis. In this case the transmitter unit is accurately aligned with the X axis line 92 is along the X axis of the graph. Line 94 is the straightness along the Y axis. In this case the X and Y axes of the machine are not accurately perpendicular, so the straightness error along the Y axis increases with distance travelled by the optic unit. The angle 96 between lines 92 and 94 is the measured machine squareness between the X and Y axes. If the kinematics between the base plate and the transmitter unit are precise, then this measured machine squareness 96 is the actual machine squareness. However, if the base plate has been calibrated for base plate squareness errors, this must be taken into account in determining the squareness. Angle 98 is the squareness error in the base plate and is deducted from the measured machine squareness to determine the actual machine squareness 100.

By measuring squareness between the three axes in addition to the six degrees of freedom for each axes, a total of 21 degrees of freedom are measured. All 21 degrees of freedom are required to calculate the error at any point in the measurement volume.

The light sources (42A,42B,42C in FIG. 2) typically comprise a diode. However a laser is a heat source and lack of thermal stability may cause it to move slightly. Movement of the laser causes the beam pointing to move and thus the beam centroid on the sensor also moves, which affects accuracy. This problem is overcome by using an optical fibre to remove the heat source from the light source, as shown in FIG. 9. The fibre gives a stable aperture from which the light is emitted.

FIG. 9 shows light from a laser 92 being focused by lens 94 into a first end 96 of an optical fibre 98. Light emitted by a second end 100 of the optical fibre 98 passes through a mount 102 before being collimated by lens 104 into a substantially parallel beam 106. The second end 100 of the optical fibre 98 acts as the launch for the light beam, ie the effective start of the light beam, with the effect that the launch (effective light source) (end 100) and heat source (laser 92) have been separated. Movement of the laser 92 due to heat has no effect on the beam pointing of the light emitted by end 100 of the optical fibre 98. Furthermore, the mount 102 and lens 104 are provided with axial symmetry such that they expand evenly and if there is movement of the mount, it comprises expansion symmetric about the axis or expansion along the axis rather than tilting movement which would effect the beam pointing. The mount may be made of all the same material, so that the coefficient of expansion is the same throughout. This enables beam pointing stability of better than a micro Radian to be achieved.

It is important that the projected light beams do not twist relative to one another, as this would induce a roll error. FIG. 10 illustrates three optical fibre ends 110,112,114 mounted on a rod 116. Mounting the optical fibre ends on the rod has the advantage that a thermal gradient will not cause the rod to twist and thus no roll error is induced from this thermal gradient. The rod 116 may be provided with a hollow core 118 so that it may be cooled by blowing cool air through the core, thus minimising bowing and lengthening of the rod.

Each of the optical fibre ends 110,112,114 is mounted on a spherically-shaped portions 120,122,124 of the rod 116. A cross-section of a clamp used to mount each optical fibre end to a spherical portion is shown in FIG. 11. The clamp 126 has an aperture 128 into which is inserted a spherical portion 120 of the bar. There are three points of contact 130,132,134 between the clamp 126 and spherical portion 120 which enables the clamp to be tilted about X,Y or Z before being secured by tightening screw 136. The optical fibre ends connected to the clamps may therefore be adjusted about X,Y and Z to point the beams in the desired direction.

If a single optical fibre and a combination of mirrors and beamsplitters are used to produce the three light beams, the optical fibre, mirrors and beamsplitters may be mounted on the bar in a similar manner.

Other optical elements, such as the detectors, may be mounted on the rod. An optical element, such as an optical fibre or detector, may be mounted out of the plane of the others by mounting it to the bottom rather than the top of a clamp.

In order to accurately determine the centre of the optical beams 44,46,48 on their respective detectors 68,70,72, the beams are required to have minimal stray reflection components. However in practice it is difficult to remove the interference patterns caused by the collimating lenses and retroreflectors. To reduce these effects an incoherent light source is required, however it is difficult to collimate an incoherent light source to the required level of this apparatus. This problem is partially solved by using a coherent light source which is intensity modulated over time to cause frequency variation. The relevant time interval for the intensity modulation is the exposure time for a given pixel in the detector.

There is a minimum exposure time for a given pixel in the detector. For example, if the exposure time for a given pixel is 10 μs and the intensity is measured to an accuracy to within 1%, then without locking the exposure time to the intensity modulation signal, the light source may be modulated to greater than 10 MHz to have the desired effect.

The coherent light source may be intensity modulated by other means. For example, the light may be passed through an optical fibre which is wound around a piezoelectric material. Pulsing the piezoelectric material causes its diameter to change, resulting in variation in the optical length of the optical fibre and hence modulation of the light beam thus reducing its coherence length.

Self interference of the beam caused by thin optics in the light path produces interference patterns on the image. This is caused when some light passes straight through the optics whilst other light is doubly reflected to the back and front faces. This may be overcome by using two light sources to produce the light beam which preferably have different wavelengths and/or are modulated at different frequencies. The light beam is thereby caused to beat a high frequency which produces a short coherent length. This technique also helps remove a speckle pattern on the image caused by dust and general point defects.

Self interference of the beam caused by double reflecting on thin optics as described above is illustrated in FIG. 8A and may be avoided by using wedged optics as illustrated in FIGS. 8B and 8C. In FIG. 8A a thin plane optical element 81 is place in front of a sensor 83. A light beam 80 is incident on the plane optical element 81. Part of the light beam 80 passes straight through the optical element to the sensor, whilst another part of the light beam 83 is doubly reflected by the optical element and interferes with beam 80 to form large fringes on the image. In FIG. 8B a wedged optical element 82 having a large wedge angle is placed in front of a sensor 83. A light beam 80 is incident on the wedged optical element 82. Part of the light beam 86 passes straight through the optical element to the sensor 83, whilst another part of the light beam 88 is doubly reflected by the optical element and passes out of the optical element at an angle such that it misses the sensor 83. In FIG. 8C, the wedges optical element 84 has thin wedge angle so that the double reflected beam 90 approaches the sensor 83 at a small angle to the beam which passes straight through 86 to produce many narrow fringes which have only a small effect on the image.

Room lighting has been found to have an effect on the detection of the beam centres incident on the detectors. For example, the background lighting causes the image to flutter. In order to remove this effect the image capture period of the detectors needs to be synchronised to the room lighting, e.g. to mains frequency. In addition, to remove the effect of room lighting two images are required, one with the return beam present and one without. The difference between the two images is used to calculate the centroid.

Pixelated image sensors have a saturation level at which intensity against sensor output becomes non linear. If the detected light from the light beam is close to the saturation level of the sensor, there will be a non-linear response and this must be taken into account when subtracting background light.

Other solutions are possible to minimise the effect of background lighting. In one such solution, a narrow bandpass filter is positioned in front of the sensors. This transmits only the wavelength of the light source and rejects other wavelengths, i.e. background light.

In a second solution, a neutral density filter is placed in front of the sensors. This transmits only a certain percentage (e.g. 10%) of all incident light (i.e. both from the light source and background light). By increasing the intensity of the light source, the intensity of the light source relative to the background light is increased.

In a third solution the detectors are shaded, for example by placing them behind apertures or tubes to minimise the effect of background light. This may also be used for the retroreflectors, with the advantage that if more than one beam uses a retroreflector, stray light is reduced.

In another solution, the integration time of a pixelated sensor is chosen to reduce the effect of the background light. For a certain integration time of the sensor, the background light appears static, giving uniform background illumination. This integration time of the sensor will depend on the frequency of the background light. The optimum integration time of the sensor for a particular background condition may be determined by cycling through different integration times on the sensor and looking at the detected beam centroid. The integration time which causes the least distortion of the beam centroid is chosen. This solution has the advantage that it reduces the need for filters.

In the preferred embodiment, the optic unit contains only optical elements i.e. retroreflectors and mirrors. This ensures that measurements are not affected by dragging cables etc, affecting the movement of the optic unit which is mounted on a moving machine component. In this apparatus the detectors and light sources to which trailing leads are associated are all located in the transmitter unit which is mounted on a fixed machine component. Where the coordinate positioning apparatus is a machine tool, the optic unit may be mounted on the spindle and the transmitter unit may be mounted on the machine bed. The machine bed is very big and heavy which results in the trailing leads on the transmitter unit having very little affect on the movement of the transmitter unit. Conversely trailing leads on the optic unit which is mounted on the spindle would affect its movement and thus the accuracy of the system.

The invention is not limited to the embodiment in which the optic unit contains only optical element. FIG. 7 shows an embodiment in which the detectors 68,70,72 are located in the optic unit 12. However this embodiment has the disadvantage that both units have trailing leads (i.e. leads to the light source in the transmitter unit and to the detectors in the optic unit). These trailing leads may effect the accuracy of the system.

An advantage of the present invention is that it is not limited to taking measurements when both units are stationary. Such a stepwise method of moving the optic unit to a new position, taking the measurement when stationary, and then repeating at a new position is not time effective. The current invention allows images to be taken whilst the optic unit is in motion.

The detectors require time to detect the image, to allow the image to be processed and a signal created. The images detected whilst the optic unit is in motion will be blurred. These images are averaged over the distance moved by the optic unit.

The signals from the detectors will be noisy due to air turbulence, whether the units are moving or stationary. This is overcome by parametrically fitting the data.

For example the straightness reading sₓ may be fitted to a quadratic curve, as illustrated below.
Sₓ=a+by+cz²

Time-averaging may be required for the readings taken by the interferometer due to air turbulence, for example.

Although in a preferred embodiment three detectors and three parallel beams are required to detect deviations in all five degrees of freedom, only two detectors and two parallel beams are required in the apparatus to detect deviations in any one plane.

It is also possible to have a system of more than three beams, retroreflectors and detectors. For example, two retroreflectors may be positioned side by side, as in the above example, each of the two retroreflector having another retroreflector positioned conceptually behind them, to make a total of four. This arrangement provides more data to be average, improving accuracy.

The transmitter unit should advantageously be aligned with an axis of the machine so that as the optic unit is moved along an axis of the machine, the projected beams stay centred on the detectors. However, it may be difficult to accurately align the base plate, on which the transmitter unit is mounted, with the machine axes. FIG. 16A illustrates the transmitter unit 10 and the optic unit 12 which are positioned at an angle to the X axis of the machine axis. Light beams 102,104,106 are therefore projected from the transmitter unit at an angle to the X axis. As shown by FIG. 16B, when the optic unit 12 is moved along the X axis, the position of the incident beams 102,104,106 relative to the optic unit 12 changes, which will result in movement of the spots on the detectors and may cause the spots to move completely off the edge of the detectors.

As the position of the spot on the detector is known, this information may be used to change the vector of travel of the optic unit such that the spots remain centred on the detectors.

In a first step the optic unit is moved along the machine axis. This movement may be a predetermined distance or until the spots move off the edge of the detectors. Then, using information of spot position on the detector, the machine quill, on which the optic unit is mounted, is servoed to bring the spots back to the centre of the detectors. As the original position (x₁,y₁,z₁) and the new position (x₂,y₂,z₂) of the optic unit and the distance travelled between them are known, the vector along which the optic unit should travel to keep the spots centred can be determined. The optic unit may be driven along this axis in a smooth or in a stepped manner.

Once this vector has been determined for one axis, the same vector can be used for all other axes. If the vector is determined separately for each axis, then in order to determine squareness the vector, base plate squareness error and measured errors must all be known.

The problem of misalignment of the transmitter unit with respect to the machine axes may also be overcome by adjustment of the base plate. The base plate on which the transmitter unit is mounted is preferably provided with an adjustment mechanism for adjusting the position of the transmitter unit in pitch, roll and yaw. A possible mechanism for the adjustable base plate is described in PCT application no PCT/GB03/000175.

As in the previous method, the optic unit is moved along the machine axis. This movement may be a predetermined distance or until the spots move off the edge of the detectors. The position of the spots on the detectors is known and using this information, the angle of the base plate is adjusted until the spots return to the centres of the detectors, thereby aligning the transmitter unit with the machine axis. Feedback from the detectors is used to inform the user about which axes the base plate should be adjusted and by how much. This could either be a manual adjuster, or the base plate adjustment mechanism may be motorised so that the base plate is adjusted automatically using feedback from the camera. In the latter case, the motors are used in this alignment procedure and then turned off.

1-25. (canceled)

26. Apparatus for measuring straightness in at least one plane and at least one of pitch and yaw in the movement of a first body with respect to a second body along an axis, the apparatus comprising:
a transmitter unit mountable on the first body;
an optic unit mountable on the second body;
wherein the transmitter unit directs at least one light beam towards the optic unit;
wherein one of the transmitter unit and the optic unit is provided with at least one detector to detect two or more light beams,
wherein the detection method for each light beam is substantially the same;
and wherein the displacement of the two or more light beams incident on the at least one detector enables measurement of straightness error in at least one plane and at least one of pitch and yaw during said movement of the first body relative to the second body.

27. Apparatus according to claim 26 wherein displacement of the two or more light beams incident on the at least one detector also enables measurement of roll error during said movement of the first body relative to the second body.

28. Apparatus according to claim 26 wherein a common equation may be used to determine different deviations.

29. Apparatus according to claim 26 wherein three light beams are detected at said at least one detector, such that pitch, roll, yaw errors or straightness errors in two planes are determined.

30. Apparatus according to claim 26 wherein the optic unit is provided with two or more optical elements to reflect said two or more light beams towards the transmitter unit

31. Apparatus according to claim 30 wherein the two or more optical elements comprise two or more retroreflectors.

32. Apparatus according to claim 31 wherein two of the retroreflectors are positioned side-by-side in the optic unit and the third retroreflector is positioned behind one of the first and second retroreflectors.

33. Apparatus according to claim 32 wherein the third retroreflector is positioned conceptually behind one of the first and second retroreflectors.

34. Apparatus according to claim 26 wherein the at least one detector comprise at least one pixelated image sensor.

35. Apparatus according to claim 26 wherein the two or more light beams remain substantially parallel when transmitted and/or reflected.

36. Apparatus according to claim 26 wherein the two or more light beams remain substantially collimated throughout the system.

37. Apparatus according to claim 26 wherein said at least two light beams are transmitted from at least one coherent light source and wherein the light beams are intensity modulated to reduce their coherence length.

38. Apparatus according to claim 37 wherein the light beams are intensity modulated to cause frequency variation which reduces the coherence pattern of the detected beams.

39. Apparatus according to claim 38 wherein said at least two light beams are intensity modulated by turning the at least one light source on and off.

40. Apparatus according to claim 26 wherein a light source is provided to produce the at least one beam and wherein an optical fibre separates the light source from the start of the projected light beam.

41. Apparatus according to claim 26 wherein at least one optical element within the system is mounted on a bar to reduce movement of the optical element due to expansion.

42. Apparatus according to claim 41 wherein the bar is thermally stabilised to minimise expansion of the bar and thus minimise movement of the at least one optical element mounted on the bar.

43. Apparatus for measuring squareness of the axes of a machine having first and second parts movable relative to one another, the apparatus comprising:
a base unit mountable on the first machine part;
a transmitter unit mountable on the base unit, the base unit and at least one surface of the transmitter unit being provided with cooperating elements to define the position of the transmitter unit relative to the base unit in a plurality of known relative orientations of the transmitter unit and thereby define the directions of at least one light beam;
an optic unit mounted on the second machine part;
wherein the transmitter unit directs at least one light beam towards the optic unit;
wherein one of the transmitter unit and the optic unit is provided with one or more detectors to detect one or more light beams transmitted to or reflected from the optic unit;
such that by orientating the transmitter unit along two axes of the base unit and measuring the lateral displacement of the at least one light beam on the at least one detector, the squareness of those two axes can be determined.

44. Apparatus for measuring deviation in the movement of a first body with respect to a second body comprising:
a transmitter unit mountable on the first body;
an optic unit mountable on the second body;
wherein the transmitter unit directs at least one light beam towards the optic unit;
wherein one of the transmitter unit and the optic unit is provided with one or more detectors to detect one or more light beams transmitted to or reflected from the optic unit;
wherein the position of the light beam on the detector is used as feedback to adjust the position of the transmitter unit or change the movement vector of the second body in order to maintain the light beam on the detector during relative movement of the first and second bodies.

45. Apparatus according to claim 43 wherein the transmitter unit is mounted on an adjustable base unit which is mounted on the first body and wherein the position of the transmitter unit is adjusted by adjusting the adjustable base unit.
